(19) United States
(12) Patent Application Publication
(10) Pub. No.: US 2012/0319538 A1
(43) Pub. Date: Dec. 20, 2012

(54) SPINDLE MOTOR

(75) Inventor: Il Geun JEON, Gyunggi-do (KR)

(73) Assignee: SAMSUNG ELECTRO-MECHANICS CO., LTD., Gyunggi-do (KR)

(21) Appl. No.: 13/233,753

(22) Filed: Sep. 15, 2011

(30) Foreign Application Priority Data
Jun. 14, 2011 (KR) 10-2011-0057609

(51) Int. Cl. H02K 7/00

(52) U.S. Cl. 310/67 R

(57) ABSTRACT

Disclosed herein is a spindle motor including: a base provided with a rotating shaft and a fitting part coupled with a sleeve supporting the rotating shaft and provided with a protruding part protruded to the outside along a circumference of an outer peripheral surface of the fitting part. According to the present invention, the structure in which the inner diameter surface is assembled in the base can be implemented without a separate additional part and the structure in which the inner diameter surface of the core is assembled in the base can be implemented, thereby improving the rotation torque.

### CROSS REFERENCE TO RELATED APPLICATION

This application claims the benefit of Korean Patent Application No. 10-2011-0057609, filed on Jun. 14, 2011, entitled “Spindle motor”, which is hereby incorporated by reference in its entirety into this application.

### BACKGROUND OF THE INVENTION

1. Technical Field

The present invention relates to a spindle motor.

2. Description of the Related Art

Generally, a spindle motor, which belongs to a brushless-DC motor (BLDC), has been widely used as a laser beam scanner motor for a laser printer, a motor for a floppy disk drive (DD), a motor for an optical disk drive such as a compact disk (CD) or a digital versatile disk (DVD), or the like, in addition to a motor for a hard disk drive.

A base is provided with a spindle motor as described above, forms an appearance thereof, is coupled with a printed circuit board, and is connected to a personal computer (PC) by a connector of the printed circuit board. Generally, the base is manufactured by machining an aluminum material by a die-casting method and then, performing additional detailed machining However, the method of manufacturing the base by the die-casting method degrades productivity when mass produced due to the increase in a lead time involved in production and makes a process complicated and troublesome due to a separate process such as additional machining. Therefore, in order to solve the above problem, there is a need to manufacture the base by a press machining method in consideration of quality and productivity of products.

However, the manufacturing thickness of the base is limited due to the manufacturing of the base using the press machining method, such that the base may not effectively support a core assembled therein. In particular, a structure in which an outer diameter surface of the core is assembled in the base has a problem of relatively degrading a rotation torque since magnetic field is formed at an inner diameter surface of the core.

### SUMMARY OF THE INVENTION

The present invention has been made in an effort to provide a spindle motor with to which a protruding part support a core is provided so as to couple an inner diameter surface of the core with a fitting part of a base.

According to a preferred embodiment of the present invention, there is provided a spindle motor, including: a base provided with a rotating shaft and a fitting part coupled with a sleeve supporting the rotating shaft and provided with a protruding part protruded to the outside along a circumference of an outer peripheral surface of the fitting part.

The protruding part may be manufactured by a press machining of the base.

The spindle motor may further include a core axially coupled with the outer peripheral surface of the fitting part and having a winding coil seated on the protruding part wound therearound.

The protruding parts may be formed at three points at a distance corresponding to each other along the circumference of the outer peripheral surface of the fitting part.

The base may be provided with at least two protruding parts at a distance corresponding to each other along the circumference of the outer peripheral surface of the fitting part.

### BRIEF DESCRIPTION OF THE DRAWINGS

FIG. 1 is a perspective view of a fitting part of a base according to a preferred embodiment of the present invention.

FIG. 2 is a plan view of a fitting part of the base according to the preferred embodiment of the present invention.

FIG. 3 is a partially cross-sectional view of a spindle motor provided with the base according to the exemplary embodiment of the present invention.

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. In addition, an “axis direction” means a direction from above to under based on a rotating shaft and in a preferred embodiment of the present invention, a core 21 seated into a protruding part formed on an outer peripheral surface of a fitting part is coupled axially from above. In describing the present invention, a detailed description of related known functions or configurations will be omitted so as not to obscure the gist of the present invention.

Hereinafter, exemplary embodiments of the present invention will be described in detail with reference to the accompanying drawings.

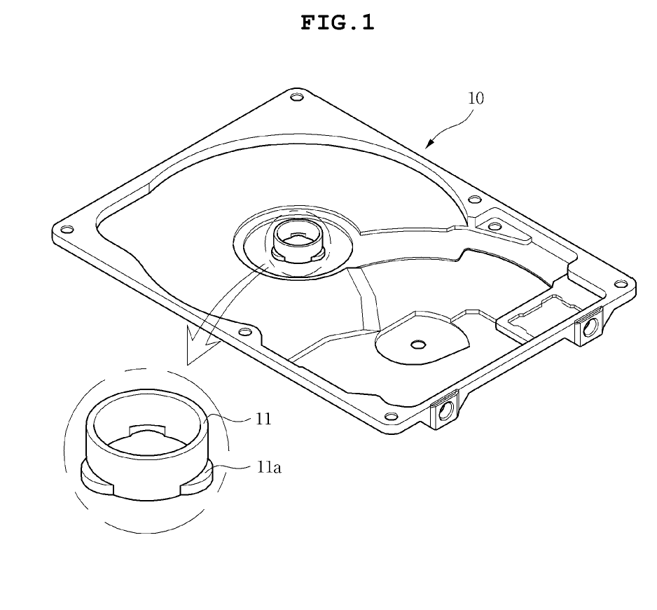

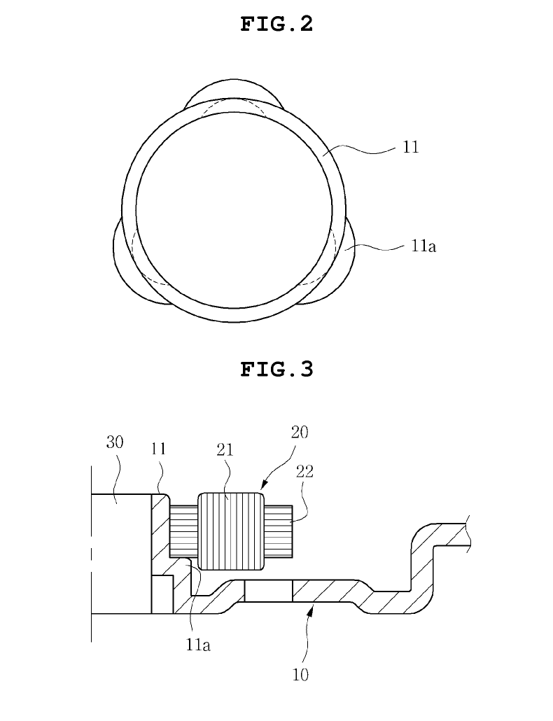

FIG. 1 is a perspective view of a fitting part of a base according to a preferred embodiment of the present invention, FIG. 2 is a plan view of a fitting part of the base according to the preferred embodiment of the present invention, and FIG. 3 is a partially cross-sectional view of a spindle motor provided with the base according to the exemplary embodiment of the present invention.

As a preferred embodiment of the present invention, a spindle motor includes a base provided with a rotating shaft and a fitting part 11 coupled with a sleeve 30 supporting the rotating shaft and provided with a protruding part 11a protruded to the outside along a circumference of an outer peripheral surface of the fitting part 11.

The rotating shaft forms a rotation center of the spindle motor and the sleeve 30 may be provided with a coupling hole (not shown) so as to be coupled with the rotating shaft while supporting the rotating shaft. A contact surface of the inner peripheral surface of the coupling hole of the sleeve 30 and the outer peripheral surface of the rotating shaft may be provided with a fluid dynamic pressure bearing of a radial bearing part or a thrust bearing part into which the rotating shaft is inserted by a working fluid, wherein the working fluid may mainly use oil but is not necessarily limited thereto. If the working fluid has the same function and effect, various types of working fluids may be used.

The base 10, which is provided with the spindle motor, is mounted with a head assembly writing and reading a disk and other parts (not shown) and is coupled with a cover member (not shown) covering a top of the base 10 to be mounted in a personal computer (PC). The base 10 according to a preferred embodiment of the present invention may be formed by a press machining method. In this case, the base 10 may be variously made of aluminum, an aluminum alloy material, a steel plate, or the like. A lead time involved in production is saved by manufacturing the base 10 using the press machining method and therefore, mass production is easily implemented, the productivity is improved by removing the separate additional machining process, manufacturing costs are saved and quality of the product is improved by simplifying the process. However, the manufacturing thickness of the base 10 has a limitation due to the manufacturing of the base 10 by the pressing machining which does not to effectively support the core 21, such that the outer diameter surface of the core 21 is assembled in the base 10. However, the structure in the base 10 is assembled in the outer diameter surface of the core 21 relatively degrades the rotation torque as compared with the structure in which the base 10 is assembled in the inner diameter surface of the core 21 since the magnetic field is formed in the inner diameter surface of the core 21.

The base 10 according to a preferred embodiment of the present invention is provided with the rotating shaft and the fitting part 11 coupled with the sleeve 30 supporting the rotating shaft and is provided with a protruding part 11a protruded to the outside along a circumference of the outer peripheral surface of the fitting part 11. In this configuration, the protruding part 11a may be integrally manufactured at the time of manufacturing the base 10 using the press machining and the protruding part 11a supports the core 21 so that the inner diameter surface of the core 21 may be assembled in the base 10. In addition, the protruding part 11a formed on the outer peripheral surface of the fitting part 11 of the base 10 may be partially provided with at least two protruding parts 11a and the contact surface of the inner peripheral surface of the coupling hole of the sleeve 30 and the outer peripheral surface of the rotating shaft may support and maintain the entire length of the fluid dynamic pressure bearing part by the working fluid. In addition, the inner diameter surface of the core 21 is coupled with the outer peripheral surface of the fitting part 11 of the base 10 to form magnetic field on the outer peripheral surface thereof, thereby increasing the entire rotation torque of the spindle motor.

The protruding part 11a is seated into the inner diameter surface of the core 21 to be protruded to the outside along the circumference of the outer peripheral surface of the fitting part 11 of the base 10 and may be formed at three points at the same distance in order to balance the support force that seats the inner diameter surface of the core 21 and the support force that supports the entire length of the fluid dynamic pressure bearing part on the contact surface of the inner peripheral surface of the coupling hole of the sleeve 30 and the outer peripheral surface of the rotating shaft by the working fluid, thereby forming the support points (see FIG. 2). That is, the protruding part Ila is formed at three positions at equidistance along the circumference of the outer peripheral surface of the fitting part 11, such that the support force that assembles and couples the inner diameter surface of the core 21 in the base 10 and the support force that supports the entire length of the fluid dynamic pressure bearing part on the contact surface of the inner peripheral surface of the coupling hole of the to sleeve 30 and the outer peripheral surface of the rotating shaft may be simultaneously satisfied.

As shown in FIG. 3, the core 21 is formed to have a winding coil 22 wound therearound and is formed to correspond to the outer peripheral surface of the fitting part 11 of the base 10 and is coupled to the fitting part 21 axially from above. The inner diameter surface of the core 21 is coupled with the outer peripheral surface of the fitting part 11 of the base 10 and is supported by the protruding part 11 a protruded to the outside along the circumference of the outer peripheral surface of the fitting part 11. As described above, the protruding part 11a may be formed at two partial positions and at three portions at equidistance, thereby increasing the efficiency. In addition, the protruding part 11a may change a design to meet the size and purpose of the spindle motor and the protruding part 11a may be consecutively formed along the circumference of the outer peripheral surface of the fitting part 11 of the base 10. However, in order to support the support force coupling the inner diameter surface of the core 21 with the outer peripheral surface of the fitting part 11 of the base 10 and the entire length of the fluid dynamic bearing part on the contact surface of the inner peripheral surface of the coupling hole of the sleeve 30 and the outer peripheral surface of the rotating shaft by the working fluid, forming the partial protruding part 11a is as described above.

As set forth above, the exemplary embodiment of the present invention can save the lead time involved in the production and improve the productivity by manufacturing the base and the protruding part using the press machining.

Further, the preferred embodiment of the present invention can implement the structure in which the inner diameter surface of the core is assembled in the base without requiring the separate additional parts.

In addition, the preferred embodiment of the present invention can improve the rotation torque by implementing the structure in which the inner diameter surface of the core is assembled in the base.

Further, the preferred embodiment of the present invention can improve the rotation torque while supporting the length of the bearing assembling surface by partially forming the protruding part along the circumference of the outer peripheral surface of the fitting part of the base.

In addition, the preferred embodiment of the present invention can secure the structural rigidity of the protruding part and improve the convenience of manufacturing by integrally forming the protruding part of the base using the press machining.

Although the preferred embodiments of the present invention have been disclosed for illustrative purposes, they are for specifically explaining the present invention and thus a spindle motor according to the present invention is not limited thereto, but those skilled in the art will appreciate that various modifications, additions and substitutions are possible, without departing from the scope and spirit of the invention as disclosed in the accompanying claims.

Accordingly, such modifications, additions and substitutions should also be understood to fall within the scope of the present invention.

What is claimed is:

1. A spindle motor, comprising:
a base provided with a rotating shaft and a fitting part coupled with a sleeve supporting the rotating shaft and provided with a protruding part protruded to the outside along a circumference of an outer peripheral surface of the fitting part.

2. The spindle motor as set forth in claim 1, wherein the protruding part is manufactured by a press machining of the base.

3. The spindle motor as set forth in claim 1, further comprising a core axially coupled with the outer peripheral surface of the fitting part and having a winding coil seated on the protruding part wound therearound.

4. The spindle motor as set forth in claim 1, wherein the protruding parts are formed at three points at a distance corresponding to each other along the circumference of the outer peripheral surface of the fitting part.

5. The spindle motor as set forth in claim 1, wherein the base is provided with at least two protruding parts at a distance corresponding to each other along the circumference of the outer peripheral surface of the fitting part.
